(19) United States
(12) Patent Application Publication
(10) Pub. No.: US 2026/0285351 A1
(43) Pub. Date: Sep. 24, 2026

(54) DRIVING ASSISTANCE APPARATUS AND DRIVING ASSISTANCE METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Yukinori SAWADA, Tokyo (JP); Norio IMAI, Tokyo (JP)

(21) Appl. No.: 19/570,538

(22) Filed: Mar. 18, 2026

(30) Foreign Application Priority Data
Mar. 21, 2025 (JP) 2025-046754

(51) Int. Cl. B60W 50/14; B60K 35/28; B60W 60/00; G06V 20/58

(52) U.S. Cl. CPC B60W 50/14; B60K 35/28; B60W 60/0015; G06V 20/58; B60K 2360/176; B60K 2360/178; B60K 2360/1868; B60W 2050/146; B60W 2420/403; B60W 2554/4041; B60W 2554/80; B60W 2556/50

(57) ABSTRACT

A driving assistance apparatus acquires a surrounding-area image that is an image of an area surrounding a vehicle. The surrounding-area image includes a normal image and an obstacle image that mainly shows an obstacle. The driving assistance apparatus acquires a distance between the vehicle and the obstacle. The driving assistance apparatus performs driving assistance control causing the vehicle to travel on a travel route prescribed in advance. The driving assistance apparatus displays the surrounding-area image in a display apparatus mounted in the vehicle. The driving assistance apparatus displays the normal image in response to the distance being equal to or greater than a threshold prescribed in advance, and displays the obstacle image in response to the distance being less than the threshold distance.

### CROSS-REFERENCE TO RELATED APPLICATIONS

This application is based on and claims the benefit of priority from Japanese Patent Application No. 2025-046754, filed on March 21, 2025. The entire disclosure of the above application is incorporated herein by reference.

### BACKGROUND

The present disclosure relates to a driving assistance apparatus and a driving assistance method.

As a driving assistance apparatus, a technology is known in which an image of an area surrounding a vehicle is displayed to an occupant. A technology is known in which, when the vehicle approaches an obstacle, a bird’s eye-view image of a wide area is switched to a bird’s-eye view image having a narrower field of view.

### SUMMARY

One aspect of the present disclosure provides a driving assistance apparatus. The driving assistance apparatus acquires a surrounding-area image that is an image of an area surrounding a vehicle. The surrounding-area image includes a normal image and an obstacle image that mainly shows an obstacle. The driving assistance apparatus acquires a distance between the vehicle and the obstacle. The driving assistance apparatus performs driving assistance control causing the vehicle to travel on a travel route prescribed in advance. The driving assistance apparatus displays the surrounding-area image in a display apparatus mounted in the vehicle. The driving assistance apparatus displays the normal image in response to the distance being equal to or greater than a threshold prescribed in advance, and displays the obstacle image in response to the distance being less than the threshold distance.

### BRIEF DESCRIPTION OF THE DRAWINGS

In the accompanying drawings:

FIG. 1 is an overall diagram illustrating a configuration of a driving assistance system;

FIG. 2 is an explanatory diagram of cameras;

FIG. 3 is a diagram illustrating an example of a normal image;

FIG. 4 is a diagram illustrating an example of an obstacle image;

FIG. 5 is a flowchart illustrating an example of a driving assistance process;

FIG. 6 is a flowchart illustrating an example of a driving assistance process according to a second embodiment;

FIG. 7 is a diagram illustrating a modification of the normal image;

FIG. 8 is a diagram illustrating a modification of the obstacle image; and

FIG. 9 is a diagram illustrating another modification of the obstacle image.

### DESCRIPTION OF THE EMBODIMENTS

As a driving assistance apparatus, a technology is known in which an image of an area surrounding a vehicle is displayed to an occupant. JP 2024-013761 A describes a technology in which, when the vehicle approaches an obstacle, a bird’s eye-view image of a wide area is switched to a bird’s-eye view image having a narrower field of view.

To confirm safety of the area surrounding the vehicle, the bird’s-eye view image merely being switched from a wide area to a narrow area is insufficient.

It is thus desired to solve the above-described issue. The present disclosure can be implemented according to the following embodiments and their modifications.

A first exemplary embodiment of the present disclosure provides a driving assistance apparatus that includes: at least one of (i) a circuit and (ii) a processor with a memory storing computer program code executable by the processor, the at least one of the circuit and the processor configured to implement: an image acquisition unit that acquires a surrounding-area image that is an image of an area surrounding a vehicle, the surrounding-area image including a normal image and an obstacle image that mainly shows an obstacle; a distance acquisition unit that acquires a distance between the vehicle and the obstacle; a control unit that performs driving assistance control causing the vehicle to travel on a travel route prescribed in advance; and a display control unit that displays the surrounding-area image in a display apparatus mounted in the vehicle, the display control unit displaying the normal image in response to the distance being equal to or greater than a threshold prescribed in advance, and displays the obstacle image in response to the distance being less than the threshold distance.

A second exemplary embodiment of the present disclosure provides a driving assistance method for causing a vehicle to travel on a travel route prescribed in advance, the driving assistance method including: an image acquisition step of acquiring a surrounding-area image that is an image of an area surrounding a vehicle, the surrounding-area image including a normal image and an obstacle image that mainly shows an obstacle; a distance acquisition step of acquiring a distance between the vehicle and the obstacle; and a display step of displaying the surrounding-area image in a display apparatus mounted in the vehicle, in which the display step includes a step of displaying the normal image in response to the distance being equal to or greater than a threshold distance prescribed in advance, and a step of displaying the obstacle image in response to the distance being less than the threshold distance.

A third exemplary embodiment of the present disclosure provides a non-transitory computer-readable storage medium storing therein a driving assistance program that causes a vehicle to travel on a travel route prescribed in advance, the driving assistance program causing at least one processor to implement: acquiring a surrounding-area image that is an image of an area surrounding a vehicle, the surrounding-area image including a normal image and an obstacle image that mainly shows an obstacle; acquiring a distance between the vehicle and the obstacle; and displaying the surrounding-area image in a display apparatus mounted in the vehicle, in which displaying the surrounding-area image comprises displaying the normal image in response to the distance being equal to or greater than a threshold distance prescribed in advance, and displaying the obstacle image in response to the distance being less than the threshold distance.

As a result of the driving assistance apparatus according to these exemplary embodiments, when the vehicle approaches the obstacle, the display control unit switches to the obstacle image that mainly shows the obstacle. Therefore, safety can be more thoroughly confirmed.

### A: First embodiment

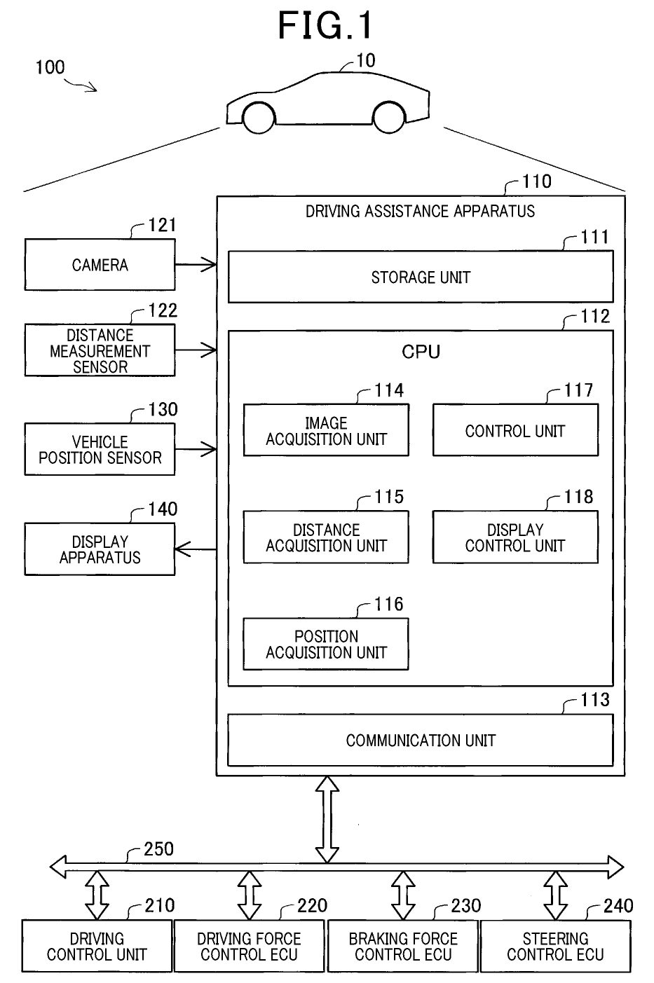

As shown in FIG. 1, a vehicle 10 includes a driving assistance system 100. According to a present embodiment, the driving assistance system 100 performs autonomous driving of the vehicle 10 as driving assistance. According to the present embodiment, the driving assistance system 100 includes a driving assistance apparatus 110, a camera 121, a distance measurement sensor 122, a vehicle position sensor 130, a display apparatus 140, a driving control unit 210, a driving force control electronic control unit (ECU) 220, a braking force control ECU 230, and a steering control ECU 240. The driving assistance apparatus 110, the driving force control ECU 220, the braking force control ECU 230, and the steering control ECU 240 are connected by an in-vehicle network 250. Here, the vehicle 10 is not limited to autonomous driving and may be driven by manual driving performed manually by a driver.

The camera 121 captures an image of an area surrounding the vehicle 10. According to the present embodiment, the vehicle 10 includes a plurality of cameras 121. The plurality of cameras 121 capture images in differing directions. Details of the directions in which the plurality of cameras 121 capture images will be described hereafter.

The distance measurement sensor 122 measures a distance to an object in the area surrounding the vehicle 10. For example, Light Detection and Ranging (LiDAR), a millimeter-wave radar, a sonar, and the like that use reflected waves can be used as the distance measurement sensor 122.

The vehicle position sensor 130 detects a current vehicle position of the vehicle 10. For example, a sensor that receives global navigation satellite system (GNSS) signals can be given as the vehicle position sensor 130.

The display apparatus 140 is capable of displaying images. According to the present embodiment, the display apparatus 140 is a display in a car navigation system.

The driving assistance apparatus 110 performs driving assistance by controlling traveling of the vehicle 10. The driving assistance apparatus 110 is configured by a computer that includes a storage unit 111, a central processing unit (CPU) 112, and an input/output interface 113. The storage unit 111 is configured by a read-only memory (ROM), a random access memory (RAM), and the like. The storage unit 111, the CPU 112, and the input/output interface 113 are connected to be capable of bidirectional communication.

The storage unit 111 is configured by the ROM, the RAM, and the like. According to the present embodiment, the storage unit 111 stores therein a travel route. For example, the travel route may be a route from a departure position prescribed arbitrarily to a parking space near a home.

The CPU 112 implements functions of an image acquisition unit 114, a distance acquisition unit 115, a position acquisition unit 116, a control unit 117, and a display control unit 118 by executing a program installed in advance in the storage unit 111. However, some or all of the functions provided by these units may be implemented by a hardware circuit.

The image acquisition unit 114 acquires a surrounding-area image from the camera 121. The surrounding-area image is an image of the area surrounding the vehicle 10. The surrounding-area image includes a normal image and an obstacle image that mainly shows an obstacle. The obstacle image is captured such that the obstacle is a main focus, compared to the normal image. Details of the normal image and the obstacle image will be described hereafter.

The distance acquisition unit 115 acquires a distance between the vehicle 10 and the obstacle, and a position of the obstacle, from the distance measurement sensor 122. The obstacle is an object that obstructs traveling of the vehicle 10 in an advancing direction. For example, another vehicle that is parked or stopped, a pedestrian, a worksite fence, a wheel chock, a step, and a wall are applicable as the obstacle. According to the present embodiment, the distance acquisition unit 115 uses the information measured by the distance measurement sensor 122 to detect an obstacle present ahead of the vehicle 10 in the advancing direction, and acquire the distance from the vehicle 10 to the obstacle and the direction in which the obstacle is positioned.

The position acquisition unit 116 acquires the current vehicle position of the vehicle 10 from the vehicle position sensor 130. For example, the position acquisition unit 116 acquires coordinates indicating a latitude and a longitude of the vehicle 10 as the vehicle position.

The control unit 117 performs driving assistance control of the vehicle 10 to cause the vehicle 10 to travel on a travel route prescribed in advance. According to the present embodiment, the control unit 117 performs automatic parking in which the vehicle 10 travels toward a target position and is parked. For example, the control unit 117 may determine a speed and a steering angle of the vehicle 10 using the position of the vehicle 10 acquired from the vehicle position sensor 130 and the travel route, and control traveling of the vehicle 10.

The display control unit 118 displays the surrounding-area image in the display apparatus 140. The display control unit 118 is able to switch the image displayed in the display apparatus 140 between the normal image and the obstacle image.

The driving control unit 210 is configured by a microcomputer or the like. The microcomputer is configured by a CPU, a RAM, and a ROM. The driving control unit 210 implements autonomous driving functions by the microcomputer executing a program installed in advance. The driving control unit 210 implements an autonomous driving function for traveling to a target position by controlling the driving force control ECU 220, the braking force control ECU 230, and the steering control ECU 240 under control of the control unit 117. For example, the driving control unit 210 may automatically change traffic lanes of the vehicle 10 by outputting deceleration to the driving force control ECU 220 and braking force control ECU 230, and outputting a steering angle to the steering control ECU 240.

The driving force control ECU 220 is an electronic control apparatus that controls a power source that generates a driving force of the vehicle 10, such as an engine. When the driver performs manual driving, the driving force control ECU 220 controls the power source that is the engine or an electric motor based on an amount of operation of an accelerator pedal. When autonomous driving is performed, the driving force control ECU 220 controls output of the engine or the electric motor based on a required driving force calculated by the driving control unit 210.

The braking force control ECU 230 is an electronic control apparatus that controls a brake actuator that generates a braking force of the vehicle 10. When the driver performs manual driving, the braking force control ECU 230 controls the brake actuator based on an amount of operation of a brake pedal. When autonomous driving is performed, the braking force control ECU 230 controls the brake actuator to control brake hydraulic pressure based on a required braking force calculated by the driving control unit 210.

The steering control ECU 240 is an electronic control apparatus that controls a motor that generates a steering torque of the vehicle 10. When the driver performs manual driving, the steering control ECU 240 controls the motor based on an operation of a steering wheel and generates assistive torque for a steering operation. As a result, the driver is able to perform steering with a small amount of force, and steering of the vehicle 10 is implemented. When autonomous driving is performed, the steering control ECU 240 performs steering by controlling the motor based on a required steering angle calculated by the driving control unit 210.

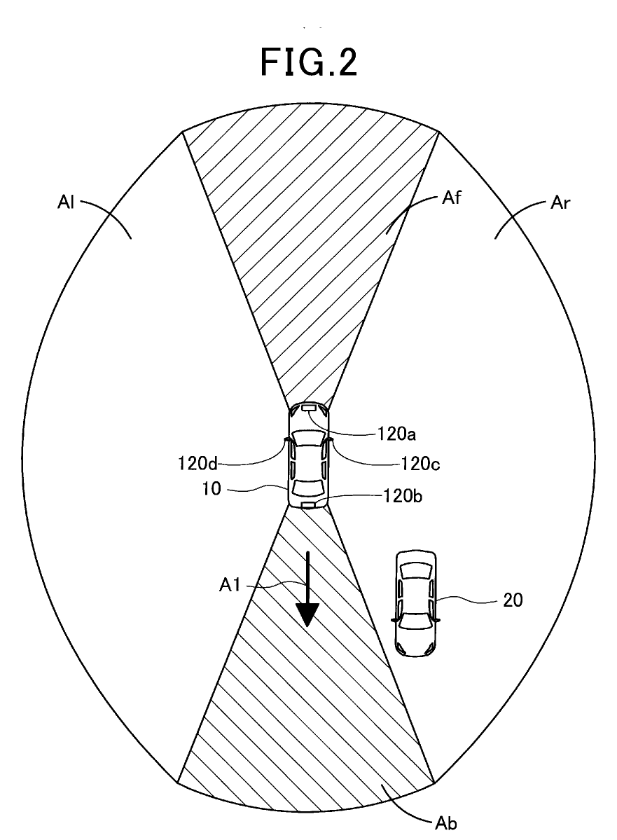

As shown in FIG. 2, according to the present embodiment, the vehicle 10 includes, as the cameras 121, a front camera 121a that captures an image of an area ahead of the vehicle 10, a rear camera 121b that captures an image of an area to the rear of the vehicle 10, a right camera 121c that captures an image of an area to the right of the vehicle 10, and a left camera 121d that captures an image of an area to the left of the vehicle 10.

According to the present embodiment, the normal image is captured by the camera 121 in the advancing direction of the vehicle 10. More specifically, the normal image is captured by the front camera 121a when the vehicle 10 is advancing straight ahead. The normal image is captured by the rear camera 121b when the vehicle 10 is moving in reverse.

The obstacle image is captured by the camera 121 in the direction in which the obstacle is positioned. More specifically, the obstacle image is captured by the front camera 121a when the obstacle is positioned in a front area Af prescribed in advance ahead of the vehicle 10. The obstacle image is captured by the rear camera 121b when the obstacle is positioned in a rear area Ab prescribed in advance to the rear of the vehicle 10. The obstacle image is captured by the right camera 121c when the obstacle is positioned in a right area Ar prescribed in advance to the right of the vehicle 10. The obstacle image is captured by the left camera 121d when the obstacle is positioned in a left area Al prescribed in advance to the left of the vehicle 10. According to the present embodiment, none of the front area Af, the rear area Ab, the right area Ar, and the left area Al overlap.

According to the present embodiment, for example, the display control unit 118 may determine the area in which the obstacle is positioned using the direction of the obstacle acquired by the distance acquisition unit 115. That is, the display control unit 118 determines which camera 121 has captured the image that is the obstacle image.

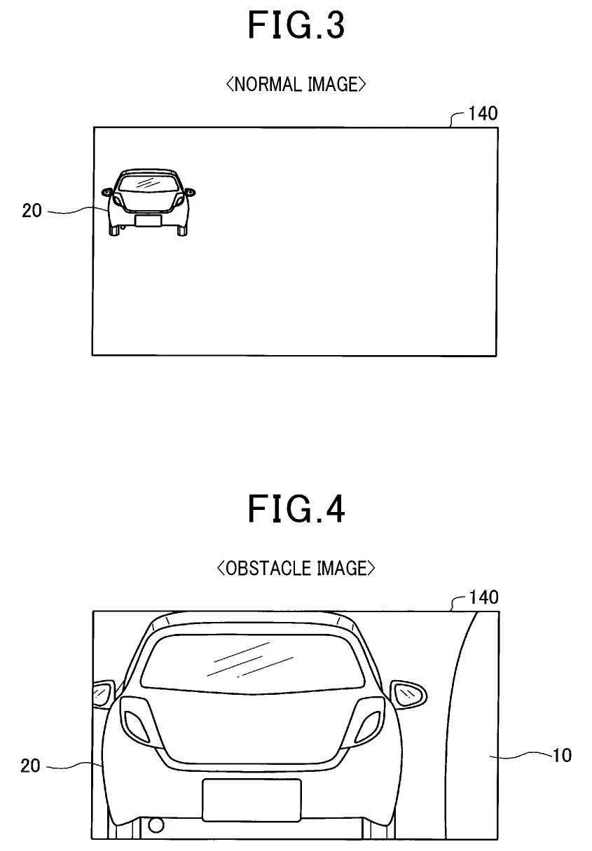

As shown in FIG. 2, a case in which the vehicle 10 is moving in reverse in an arrow A1 direction and another vehicle 20 that is an obstacle is parked to the rear right of the vehicle 10 will be described as an example. In this case, as shown in FIG. 3, the normal image is an image captured by the rear camera 121b. In addition, as shown in FIG. 4, the obstacle image is an image captured by the right camera 121c. Here, the normal image shown in FIG. 3 is the normal image when the vehicle 10 and the other vehicle 20 are sufficiently apart. In addition, the obstacle image shown in FIG. 4 is the obstacle image when the vehicle 10 has moved further in reverse and closer to the vehicle 20 than in the case shown in FIG. 3.

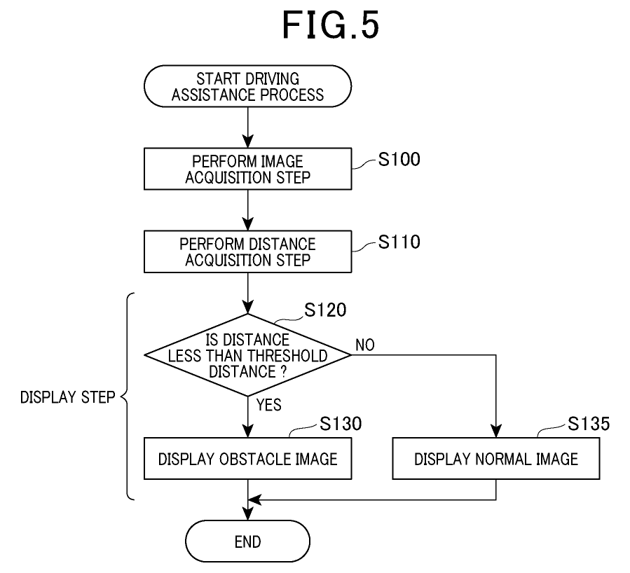

A driving assistance process shown in FIG. 5 is a process in which the driving assistance apparatus 110 displays the surrounding-area image in the display apparatus 140 in the driving assistance control by the control unit 117. This process is repeatedly performed by the driving assistance apparatus 110 during the driving assistance control by the control unit 117. For example, the process may be repeatedly performed every 100 ms.

At step S100, the image acquisition unit 114 performs an “image acquisition step” of acquiring the surrounding-area image from the camera 121.

At step S110, the distance acquisition unit 115 performs a “distance acquisition step” of acquiring the distance between the vehicle 10 and the obstacle from the distance measurement sensor 122. According to the present embodiment, when an obstacle is not be present, the distance acquisition unit 115 acquires null data. Here, step S100 and step S110 are not limited to this order and may be performed in an arbitrary order or in parallel.

At step S120, the display control unit 118 determines whether the distance acquired at step S110 is less than a threshold distance prescribed in advance. For example, the threshold distance may be 10 m. When determined that the distance is less than the threshold distance, the display control unit 118 proceeds to a process at step S130 and displays the obstacle image in the display apparatus 140. Meanwhile, when determined that the distance is greater than or equal to the threshold distance, the display control unit 118 proceeds to a process at step S135 and displays the normal image in the display apparatus 140. When the null data is acquired at step S110, the display control unit 118 determines that the distance is equal to or greater than the threshold distance and proceeds to the process at step S135. Here, the process at step S120 and the process at step S130 or step S135 are also collectively referred to as a “display step”.

As a result of the driving assistance apparatus 110 according to the present embodiment, when the vehicle 10 approaches a position that is less than a threshold to the obstacle, the display control unit 118 automatically switches to the obstacle image that mainly shows the obstacle. Therefore, safety can be more thoroughly confirmed.

### B. Second embodiment

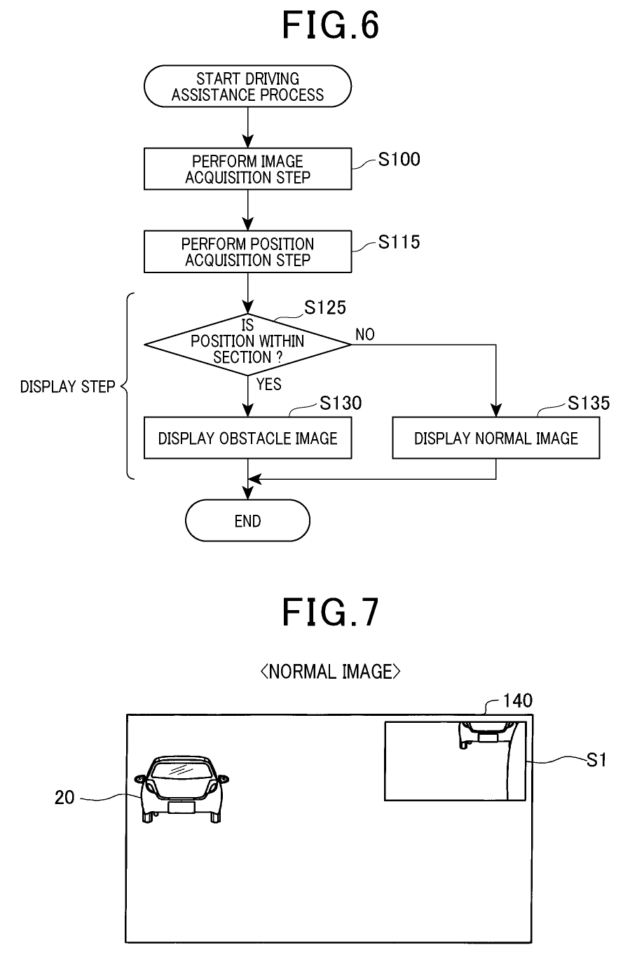

A driving assistance process according to a second embodiment shown in FIG. 6 differs from the driving assistance process according to the first embodiment in that the distance acquisition step is omitted, and the image to be displayed is determined based on whether the vehicle 10 is positioned within a section stored in the storage unit 111. Other steps are identical to those according to the first embodiment. The configuration of the driving assistance system 100 according to the second embodiment is identical to the configuration of the driving assistance system 100 according to the first embodiment. Therefore, the description of the configuration of the driving assistance system 100 is omitted.

The storage unit 111 stores therein in advance a section of the travel route in which the distance between the vehicle 10 and the obstacle is equal to or less than a threshold distance. According to the present embodiment, the obstacle is a stationary object. For example, a worksite fence, a wheel chock, a step, a wall, and the like are applicable. That is, the obstacle is an object of which presence is able to be recognized in advance before the distance measurement sensor 122 actually measures the distance, and has a high probability of being present in a predetermined position. The storage unit 111 stores therein the section set using the distance acquired by the distance acquisition unit 115. According to the second embodiment, when setting the section, the process for acquiring the distance between the vehicle and the obstacle on the travel route is also referred to as a “distance acquisition step.”

In the driving assistance process, at step S115 after step S110, the position acquisition unit 116 performs a “position information acquisition step” of acquiring the current vehicle position of the vehicle 10 from the vehicle position sensor 130. Here, step S100 and step S115 are not limited to this order and may be performed in an arbitrary order or in parallel.

At step S125, the display control unit 118 determines whether the vehicle 10 is positioned within the section using the position of the vehicle 10 acquired at step S115. When determined that the vehicle 10 is positioned within the section, the display control unit 118 proceeds to the process at step S130 and displays the obstacle image in the display apparatus 140. Meanwhile, when determined that the vehicle 10 is positioned outside the section, the display control unit 118 proceeds to the process at step S135 and displays the normal image in the display apparatus 140.

According to the driving assistance apparatus 110 according to the second embodiment described above, the section in which the distance between the vehicle 10 and the obstacle is less than the threshold distance is stored. As a result, a timing at which the display control unit 118 switches to the obstacle image can be predicted in advance. Therefore, safety can be more thoroughly confirmed.

### C. Other embodiments

(C1) According to the above-described embodiments, the driving assistance apparatus 110 is mounted in the vehicle 10. The present disclosure is not limited thereto. For example, the driving assistance apparatus 110 may include a server or a transportation infrastructure set outside the vehicle 10.

(C2) According to the above-described embodiments, the driving assistance system 100 includes the plurality of cameras 121 that capture images in differing directions. The present disclosure is not limited thereto. Only a single camera 121 may be provided. In this case, the obstacle image may be an image focusing on the obstacle or an image that is an enlargement of a portion of the normal image in which the obstacle is shown.

(C3) According to the above-described embodiments, the distance acquisition unit 115 acquires the distance between the vehicle 10 and the obstacle from the distance measurement sensor 122. The present disclosure is not limited thereto. The distance acquisition unit 115 may acquire the distance between the vehicle 10 and the obstacle from the surrounding-area image captured by the camera 121 using known image analysis technology. For example, an obstacle may be detected by pattern matching and the distance to the detected obstacle may be determined.

(C4) According to the above-described embodiments, the direction in which the obstacle is positioned is acquired by the distance acquisition unit 115 using the information measured by the distance measurement sensor 122. The present disclosure is not limited thereto. The display control unit 118 may acquire the direction in which the obstacle is positioned from by both or either of the information measured the distance measurement sensor 122 and the surrounding-area image captured by the camera 121 using a known image analysis technology. For example, an obstacle may be detected by pattern matching and the direction may be determined from the position of the camera 121 that has captured the image of the detected obstacle.

(C5) According to the above-described embodiments, the position acquisition unit 116 acquires the current vehicle position of the vehicle 10 from the vehicle position sensor 130. The present disclosure is not limited thereto. The position acquisition unit 116 may acquire a vehicle position estimated using position information acquired from road equipment such as a traffic light or an electronic bulletin board, a communication apparatus set in a commercial facility or a public facility, or the like, and a positional relationship with the vehicle 10.

(C6) According to the above-described embodiments, the threshold distance is a distance prescribed in advance. The present disclosure is not limited thereto. The threshold distance may be determined based on the speed of the vehicle 10 and an obstacle type.

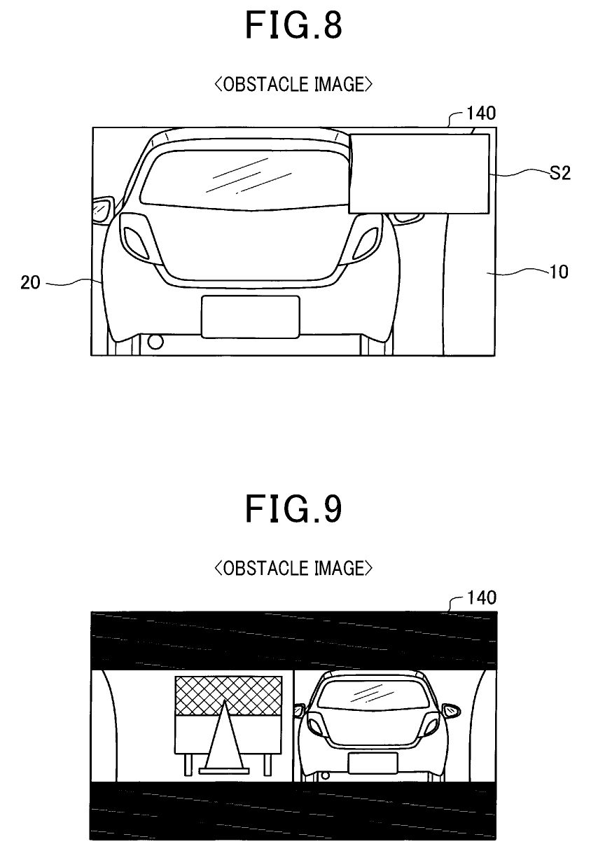

(C7) According to the above-described embodiments, the normal image is the image captured by the camera 121 in the advancing direction of the vehicle 10. The present disclosure is not limited thereto. The normal image may be a bird's-eye view image generated from the image captured by the camera 121. In addition, as shown in FIG. 7, the normal image may be such that the image captured by the camera 121 in the advancing direction of the vehicle 10 is mainly displayed, and the image captured by the camera 121 in the direction in which the obstacle is positioned is displayed in a supplementary manner. More specifically, the image captured by the camera 121 in the direction in which the obstacle is positioned is displayed in an upper right area S1 of the display apparatus 140. In this case, as shown in FIG. 8, the obstacle image is such that the image captured by the camera 121 in the direction in which the obstacle is positioned is mainly displayed, and the image captured by the camera 121 in the advancing direction of the vehicle 10 is displayed in a supplementary manner.

(C8) According to the above-described embodiments, in a case in which a plurality of obstacles are positioned less than the threshold distance from the vehicle 10, the display control unit 118 may display the obstacle image corresponding to the obstacle having a shortest distance. In addition, the display control unit 118 may simultaneously display the obstacle images respectively corresponding to the plurality of obstacles. For example, in a case in which a vehicle is parked to the rear right at less than the threshold distance, and a fence and a color cone (registered trademark) are positioned to the rear left at less than the threshold distance, as shown in FIG. 9, the display control unit 118 may divide the screen of the display apparatus 140 and display the image captured by the right camera 121c and the image captured by the left camera 121d.

(C9) According to the above-described second embodiment, when the vehicle 10 is positioned outside the section, the display control unit 118 may determine whether the distance acquired by the distance acquisition unit 115 is less than a threshold, and display the obstacle image in the display apparatus 140 when determined that the distance is less than the threshold.

The present disclosure is not limited to the above-described embodiments and can be implemented by various configurations without departing from the spirit of the invention. For example, technical features according to embodiments that correspond to technical features in each aspect described in the summary of the invention can be replaced and combined as appropriate to solve some or all of the above-described issued or to achieve some or all of the above-described effects. Furthermore, the technical features may be omitted as appropriate unless described as a requisite in the present specification.

The driving assistance apparatus 110 and a method thereof described in the present disclosure may be implemented by a dedicated computer that is provided such as to be configured by a processor and a memory, the processor being programmed to provide one or more functions that are implemented by a computer program. Alternatively, the driving assistance apparatus 110 and a method thereof described in the present disclosure may be implemented by a dedicated computer that is provided by a processor being configured by one or more dedicated hardware logic circuits. As another alternative, the driving assistance apparatus 110 and a method thereof described in the present disclosure may be implemented by one or more dedicated computers. The dedicated computer may be configured by a combination of a processor that is programmed to provide one or more functions, a memory, and a processor that is configured by one or more hardware logic circuits. In addition, the computer program may be stored in a non-transitory, computer-readable, tangible storage medium that can be read by a computer as instructions performed by the computer.

What is claimed is:

1. A driving assistance apparatus comprising:
at least one of (i) a circuit and (ii) a processor with a memory storing computer program code executable by the processor, the at least one of the circuit and the processor configured to implement:
an image acquisition unit that acquires a surrounding-area image that is an image of an area surrounding a vehicle, the surrounding-area image including a normal image and an obstacle image that mainly shows an obstacle;
a distance acquisition unit that acquires a distance between the vehicle and the obstacle;
a control unit that performs driving assistance control causing the vehicle to travel on a travel route prescribed in advance; and
a display control unit that displays the surrounding-area image in a display apparatus mounted in the vehicle, the display control unit displaying the normal image in response to the distance being equal to or greater than a threshold prescribed in advance, and displaying the obstacle image in response to the distance being less than the threshold distance.

2. The driving assistance apparatus according to claim 1, further comprising:
a storage unit that stores therein in advance a section of the travel route in which the distance is less than the threshold distance; and
a position acquisition unit that acquires a position of the vehicle, wherein
in response to the vehicle being positioned within the section, the display control unit displays the obstacle image.

3. The driving assistance apparatus according to claim 1, wherein:
in response to a plurality of obstacles being positioned less than the threshold distance from the vehicle, the display control unit displays the obstacle image corresponding to the obstacle having a shortest distance.

4. The driving assistance apparatus according to claim 2, wherein:
in response to a plurality of obstacles being positioned less than the threshold distance from the vehicle, the display control unit displays the obstacle image corresponding to the obstacle having a shortest distance.

5. The driving assistance apparatus according to claim 1, wherein:
the image acquisition unit acquires obstacle images captured by a plurality of cameras; and
in response to a plurality of obstacles being positioned less than the threshold distance from the vehicle, the display control unit simultaneously displays the obstacle images respectively corresponding to the plurality of obstacles.

6. The driving assistance apparatus according to claim 2, wherein:
the image acquisition unit acquires obstacle images captured by a plurality of cameras; and
in response to a plurality of obstacles being positioned less than the threshold distance from the vehicle, the display control unit simultaneously displays the obstacle images respectively corresponding to the plurality of obstacles.

7. A driving assistance method for causing a vehicle to travel on a travel route prescribed in advance, the driving assistance method comprising:
an image acquisition step of acquiring a surrounding-area image that is an image of an area surrounding a vehicle, the surrounding-area image including a normal image and an obstacle image that mainly shows an obstacle;
a distance acquisition step of acquiring a distance between the vehicle and the obstacle; and
a display step of displaying the surrounding-area image in a display apparatus mounted in the vehicle, wherein
the display step comprises
a step of displaying the normal image in response to the distance being equal to or greater than a threshold distance prescribed in advance, and
a step of displaying the obstacle image in response to the distance being less than the threshold distance.

8. A non-transitory computer-readable storage medium storing therein a driving assistance program that causes a vehicle to travel on a travel route prescribed in advance, the driving assistance program causing at least one processor to implement:
acquiring a surrounding-area image that is an image of an area surrounding a vehicle, the surrounding-area image including a normal image and an obstacle image that mainly shows an obstacle;
acquiring a distance between the vehicle and the obstacle; and
displaying the surrounding-area image in a display apparatus mounted in the vehicle, wherein
displaying the surrounding-area image comprises
displaying the normal image in response to the distance being equal to or greater than a threshold distance prescribed in advance, and
displaying the obstacle image in response to the distance being less than the threshold distance.
